(19) United States
(12) Patent Application Publication
(10) Pub. No.: US 2020/0290545 A1
(43) Pub. Date: Sep. 17, 2020

(54) AIRBAG SYSTEMS FOR USE ON AIRCRAFT

(71) Applicant: AmSafe, Inc., Phoenix, AZ (US)

(72) Inventor: Bradley Scott Walker, Gilbert, AZ (US)

(21) Appl. No.: 16/351,140

(22) Filed: Mar. 12, 2019

(51) Int. Cl. B60R 21/18; B64D 25/00; B60R 21/207; B60R 21/231

(52) U.S. Cl. CPC B60R 21/18; B64D 25/00; B60R 2021/0093; B60R 21/231; B60R 21/207

(57) ABSTRACT

Airbag systems for use in aircraft are described herein. In some embodiments, an occupant restraint system for use with a passenger seat on an aircraft includes an under-seat airbag and a lap belt airbag. The lap belt airbag can be operably positioned on a lap belt configured to be fastened around a seat occupant, and the under-seat airbag can be positioned proximate to a seat pan. In operation, the under-seat airbag and the lap belt airbag can inflate simultaneously, or at least approximately simultaneously, to reduce occupant forward head path excursion during a crash or other rapid deceleration event.

### TECHNICAL FIELD

The present disclosure is generally related to occupant restraint systems for use in aircraft and other vehicles and, more particularly, to occupant restraint systems having airbags.

### BACKGROUND

Airbags can protect occupants from strike hazards in automobiles, aircraft, and other vehicles. In conventional airbag systems, a sensor detects a collision or other dynamic event of sufficient magnitude and transmits a corresponding signal to an initiation device (e.g., a pyrotechnic device) on an inflator. The signal causes the inflator to release compressed gas into the airbag, rapidly inflating the airbag in front of the occupant to cushion the occupant's impact with forward objects.

Some aircraft include airbags on seat belts that are secured around the occupant's waist in a conventional manner. The airbag is typically stowed on the seat belt under a flexible cover. In the event the aircraft experiences a forward impact or other significant dynamic event, the airbag rapidly inflates, displacing the cover and deploying upward in front of the occupant to create a cushioning barrier between the occupant and a seat back, partition, monument, or other potential strike hazard in front of the occupant.

Forward head excursion during a crash event can limit how close airlines can position one row of passenger seats to another, and how close passenger seats can be positioned relative to a partition wall or other potential strike hazard. Accordingly, it is generally desirable to reduce forward head excursion so that passenger seats can be placed closer to potential strike hazards, while still maintaining enough distance to ensure that occupants do not contact the strike hazards during a crash event.

### BRIEF DESCRIPTION OF THE DRAWINGS

FIG. 1 is a front isometric view of an occupant secured in an aircraft seat by a restraint system having one or more airbags configured in accordance with embodiments of the present technology.

FIG. 2 is a partially schematic isometric view of an aircraft airbag system configured in accordance with embodiments of the present technology.

FIGS. 3A-3C are rear, front, and side views, respectively, of a lap belt airbag configured in accordance with embodiments of the present technology.

FIG. 4 is a top isometric view of an under-seat airbag configured in accordance with embodiments with the present technology.

FIGS. 5A-5C are a series of side views illustrating various stages of operation of an occupant restraint system having one or more airbags configured in accordance with embodiments with the present technology.

### DETAILED DESCRIPTION

The following disclosure describes various embodiments of airbags and associated systems for use with seats in aircraft. As described in greater detail below, in some embodiments the airbag systems can include a lap belt airbag configured to inflate from a seat belt secured around the waist of the seat occupant, and an under-seat airbag configured to inflate beneath the thighs of the seat occupant. Each of the airbags can be configured to receive high pressure gas from one or more inflators mounted under the seat or in other suitable locations. If the aircraft experiences a significant dynamic event (e.g., a crash event or other rapid deceleration) in which the occupant could be thrown forward against a structure or other strike hazard, an electronic sensing system activates the one or more inflators to instantaneously release compressed gas into the airbags, causing the airbags to rapidly inflate. The lap belt airbag inflates between the occupant's torso and thighs as the occupant rotates forward about the lap belt into the lap belt airbag. At the same time, the under-seat airbag inflates upwardly from the seat pan against the thighs of the occupant, just behind the knees, driving the occupant's legs upwardly toward the occupant's torso and into the lap belt airbag. The upward momentum of the occupant's legs reduces the forward rotation of the occupant's torso about the lap belt, thereby reducing the forward head excursion of, and potential injuries to, the occupant.

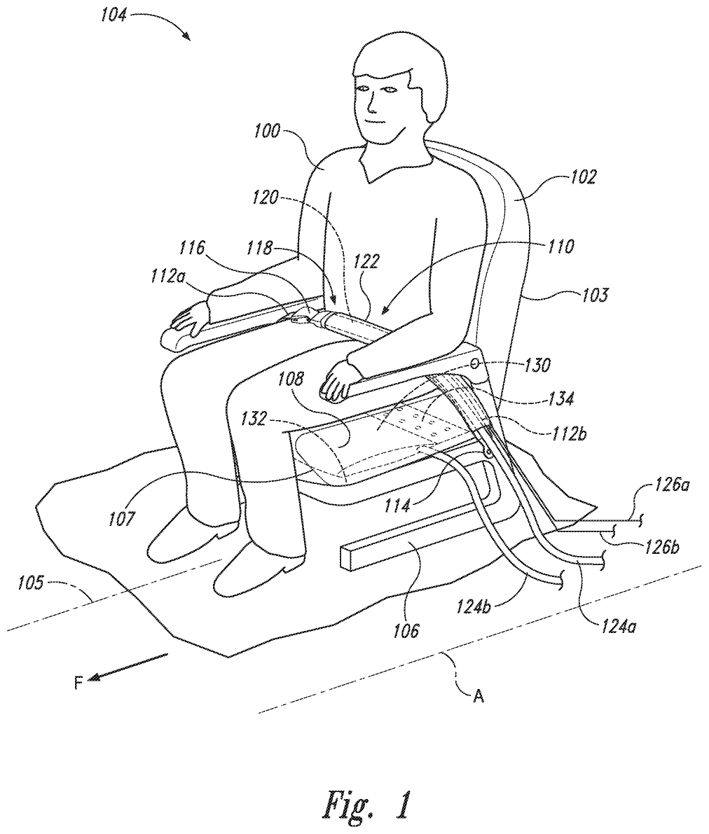

Certain details are set forth in the following description and in FIGS. 1-5C to provide a thorough understanding of various embodiments of the present technology. In other instances, other details describing well-known structures, materials, methods and/or systems often associated with airbags, airbag inflation systems and related circuitry, seat belts, seats, etc. in aircraft and other vehicles are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a front isometric view of a seat occupant 100 (e.g., a passenger) secured in a seat 102 by a restraint system 110 configured in accordance with embodiments with the present technology. In the illustrated embodiment, the seat 102 is positioned in an aircraft seating area 104, such as a passenger cabin of a commercial, private, or general aviation aircraft. For example, in some embodiments, the seat 102 can be at least generally similar in structure and function to a conventional seat in, for example, a first class or business class cabin of a commercial passenger aircraft.

In the illustrated embodiment, the seat 102 faces forward, or at least generally forward, in direction F toward the front of the aircraft. Accordingly, in this embodiment, a centerline 105 of the seat 102 extends parallel to, or at least approximately parallel to, a longitudinal axis A of the aircraft (e.g., a longitudinal axis of the aircraft fuselage). In other embodiments, the seat 102 can be positioned so that the occupant 100 faces generally forward, but with seat centerline 105 orientated at an angle (e.g., an oblique angle) relative to the longitudinal axis A. For example, in such embodiments the seat centerline 105 can be positioned at angles from about 5 degrees to about 90 degrees, or from about 10 degrees to about 45 degrees, relative to the longitudinal axis A. In other embodiments, the seat can be positioned in other orientations and/or in other settings and arrangements. Additionally, as those of ordinary skill in the art will appreciate, although only one seat 102 is illustrated in FIG. 1, in some embodiments additional seats can be positioned to one or both sides of the seat 102 to create a row of seats, and/or in front of or behind the seat 102 in additional rows. In other embodiments, the seat 102 can be positioned behind a partition (e.g., a closet or galley wall), or other structure.

In the illustrated embodiment, the restraint system 110 includes a lap belt airbag 120 and an under-seat airbag 130. The lap belt airbag 120 is carried on a lap seatbelt 118 (which can also be referred to as “two-point” restraint) having a first web portion 112a and a second web portion 112b. The web portions 112a, b can be at least generally similar in structure and function to conventional seatbelt webbing comprised of, for example, woven nylon, woven polyester, etc. A proximal end of the second web portion 112b is fixedly attached to a seat frame 106 on one side of the occupant 100 by an attachment fitting 114, and a proximal end of the first web portion112a is similarly attached to the seat frame 106 on the opposite side of the occupant 100. A distal end of the first web portion 112a carries a buckle 116 that is configured to receive and releasably engage a corresponding web connector tongue (not shown in FIG. 1) attached to the distal end of the second web portion 112b. In operation, the occupant 100 secures the seatbelt 118 around his or her waist in a conventional manner. More specifically, after sitting in the seat 102, the occupant 100 can insert the connector tongue on the second web portion 112b into the buckle 116 and adjust the tension in the seatbelt 118 in a conventional manner. To release the seatbelt 118, the occupant 100 lifts a handle on the buckle 116 or otherwise releases the connector tongue from the buckle 116 in a conventional manner.

As noted above, the lap belt airbag 120 is operably attached to the second web portion 112b of the seatbelt 118. During assembly, the airbag 120 is neatly folded and stowed under a flexible cover 122 which encloses the airbag 120 and can wrap around at least a portion of the second web portion 112b. A first gas conduit or hose 124a extends from the airbag 120 and is operably coupled in fluid communication to an airbag inflator (not shown in FIG. 1). Additionally, in some embodiments a first electrical link, e.g., a first wire 126a, and a second wire 126b can be routed under the cover 122 to a seatbelt switch (not shown) that completes a circuit or is otherwise operable to indicate when the connector tongue on the second web portion 112b is properly coupled to the buckle 116, which can be a precondition for deployment of the lap belt airbag 120 and/or the under-seat airbag 130. As described in greater detail below, upon inflation of the lap belt airbag 120 in response to, for example, a rapid deceleration of the aircraft or other accident scenario, the airbag 120 ruptures a pressure sensitive tear seam in the cover 122 that enables the cover 122 to fall away so that the airbag 120 can fully deploy.

The seat 102 includes a back portion 103 extending upwardly from a base portion 107 in a conventional manner. The base portion 107 can include a seat cushion 108 (e.g. a foam cushion) upon which the occupant 100 sits, and a seat pan 132 that supports the seat cushion 108. Prior to installation on the seat 102, the under-seat airbag 130 is folded and stowed within a flexible protective cover 134. In some embodiments, the covered under-seat airbag 130 is positioned on the seat pan 132 beneath the seat cushion 108, or beneath at least a portion of the seat cushion 108. In other embodiments, the under-seat airbag 130 can be integrated into the seat cushion 108 by, for example, positioning the under-seat airbag 130 in a cavity formed in the seat cushion.

A second gas hose 124b operably connects the under-seat airbag 130 in fluid communication with an inflator (not shown in FIG. 1). As described in greater detail below, the inflator can be a single inflator that provides high pressure gas to both the under-seat airbag 130 and the lap belt airbag 120, or a separate inflator that just provides high pressure gas to the under-seat airbag 130. Additionally, in some embodiments the under-seat air bag 130 can be inflated by a dedicated inflator that is positioned within the under-seat airbag 130. As described in greater detail below, upon deployment the under-seat airbag 130 rapidly inflates and ruptures one or more tear seams on the cover 134 as the airbag 130 expands upwardly.

In some embodiments, the restraint systems described herein can be used to protect occupants in a wide variety of vehicles, including other types of aircraft (e.g., both fixed-and-rotary-wing aircraft), land vehicles (e.g., automobiles), watercraft, etc., and with a wide variety of seating arrangements and orientations, such as center aisle seats, outer aisle seats, seats positioned directly behind other seats, monuments, walls, partitions, consoles, closets, etc., “infinite setback seats” (seats that are not positioned behind other structures), and seats in other orientations relative to, for example, the forward end of the aircraft and/or the direction F of forward travel, such as side facing seats or seats orientated at other angles relative to the longitudinal axis A of the aircraft.

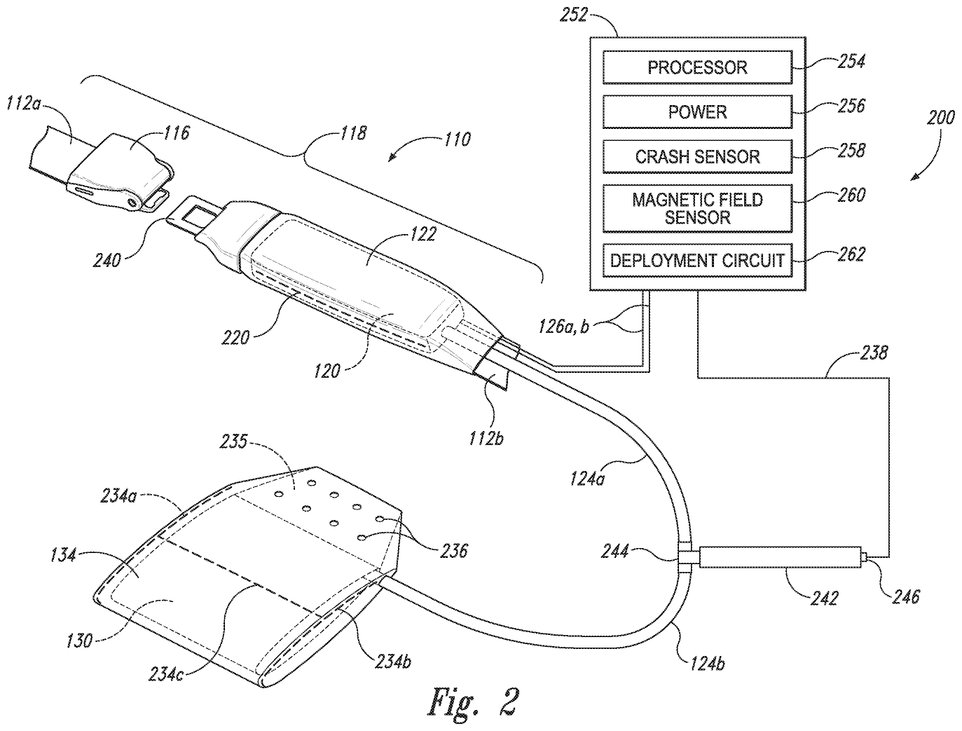

FIG. 2 is a partially schematic isometric view of the restraint system 110 and an associated airbag deployment system 200 configured in accordance with embodiments of the present technology. As noted above with reference to FIG. 1, the under-seat airbag 130 can be enclosed in a flexible and protective cover 134. The cover 134 can include one or more seams (e.g., tear seams) attached with stitching (e.g., “rip stitching”) that ruptures as the airbag 130 inflates so that the cover 134 falls away as the under-seat airbag 130 rapidly expands. For example, the cover 134 can include a first side tear seam 234a and a second side tear seam 234b. Additionally, in some embodiments the cover can also include a lateral tear seam 234c extending between the two side tear seams 234a, b. In addition to the tear seams 234a-c, the cover 134 can additionally include one or more holes 236 that extend through the cover 134 and an adjacent attachment panel 235 of the airbag 130. The holes 236 are configured to receive one or more fasteners (e.g., rivets, screws, adhesive, etc.; not shown in FIG. 2) that attach the airbag 130 and the cover 134 to the seat pan 132 (FIG. 1).

In some embodiments, the airbag deployment system 200 includes an electronic assembly 252 (e.g., an electronic module assembly (EMA); shown schematically) and an inflator 242. The electronic assembly 252 and/or the inflator 242 can be located, for example, under the seat 102 (FIG. 1), under an adjacent seat, or in other locations suitable for connectivity to the lap belt airbag 120 and the under-seat airbag 130. Various types of inflators known in the art can be used with the airbag systems described herein. In some embodiments, for example, the inflator 242 can include a stored gas canister that contains compressed gas (e.g., compressed air, nitrogen, argon, helium, etc.) at high pressure. The inflator 242 can include an initiator 246 (e.g., a pyrotechnic device such as a squib) operably positioned at one end and an outlet fitting 244 (e.g., a “T” fitting) at the opposite end that connects the first gas hose 124a and the second gas hose 124b to the inflator 242. In other embodiments, other suitable inflation devices well known in the art can be used without departing from the present disclosure. Such devices can include, for example, gas generator devices that generate high pressure gas through a rapid chemical reaction of an energetic propellant, hybrid inflators, etc. Additionally, in other embodiments the airbag deployment system 200 can include two inflators: one for inflating the lap belt airbag 120 and the other for inflating the under-seat airbag 130. In further embodiments, the under-seat airbag 130 can include a dedicated inflator positioned within the airbag 130. Accordingly, the present disclosure is not limited to any particular type of airbag inflation device and/or system.

The electronic assembly 252 can be electrically connected to the inflator initiator 246 via one or more electrical links 238 (e.g., one or more wires). As discussed above, in some embodiments the restraint system 110 can include a seatbelt switch (not shown) carried on a web connector 240 which is configured to change status (e.g., close a circuit or open a circuit) when the web connector 242 is suitably engaged with the buckle 116. The connector status as determined by the switch can be transmitted to the electronic assembly 252 via the electrical links 126a, b to ensure that the lap belt airbag 120 and/or the under-seat airbag 130 is only deployed when the two web portions 112a, b of the seatbelt web 118 are properly joined together, as this can prevent the lap belt airbag 120 and/or the under-seat airbag 130 from inadvertently inflating when the seatbelt 118 is not secured around the waist of a seat occupant.

In the illustrated embodiment, the electronic assembly 252 includes a processor 254 that receives electrical power from a power source 256 (e.g., one or more batteries, such as lithium batteries), a deployment circuit 262 that initiates the inflator 242, and at least one crash sensor 258 (e.g., an accelerometer) that detects rapid decelerations and/or other dynamic events greater than a preset or predetermined magnitude (e.g., a deceleration greater than 15g's). The processor 254 can include, for example, suitable processing devices for executing non-transitory instructions stored on a computer-readable medium. The crash sensor 258 can, for example, include a spring-mass damper type sensor with an inertial switch calibrated for the vehicles operating environments that initiates airbag deployment upon a predetermined level of deceleration. In other embodiments, the crash sensor 258 can include other types of sensors known in the art and/or other additional features to facilitate airbag deployment. In further embodiments, some of the components of the electronic assembly 252 described above may be omitted and/or other components may be included. Although specific circuitry is described above, those or ordinary skill in the art will recognize that a microprocessor-based system could also be used where any logical decisions are configured in software.

In a dynamic event above a predetermined threshold (e.g., a rapid deceleration equal to or greater than a predetermined magnitude resulting from the aircraft experiencing a collision or other significant dynamic event), the crash sensor 258 can detect the event and respond by sending a corresponding signal to the processor 254 that causes the processor 254 to send a corresponding signal to the deployment circuit 262. Upon receiving the signal and confirmation that the connector 240 is engaged with the buckle 116, the deployment circuit 262 applies a voltage to the inflator initiator 246 via the electrical link 238 sufficient to activate the initiator 246, which in turn opens or otherwise causes the inflator 242 to rapidly discharge its compressed gas into the lap belt airbag 120 and the under-seat air bag 130 via the first gas hose 124a and the second gas hose 124b, respectively. The rapid expansion of the compressed gas flowing into the lap belt airbag 120 causes the airbag 120 to rapidly inflate and rupture or otherwise separate a tear seam 220 on the airbag cover 122. This moves the cover 122 away from the lap belt airbag 120 so that the air bag 120 can quickly inflate and deploy (e.g., in about 40 to 55 milliseconds (ms)). The tear seam 220 can include stitching with suitable thread that is configured to break upon airbag inflation. In other embodiments, the tear seam 220 (and/or the tear seams 234a-c) can employ adhesive or other means to hold the cover 122 together prior to inflation of the airbag 120.

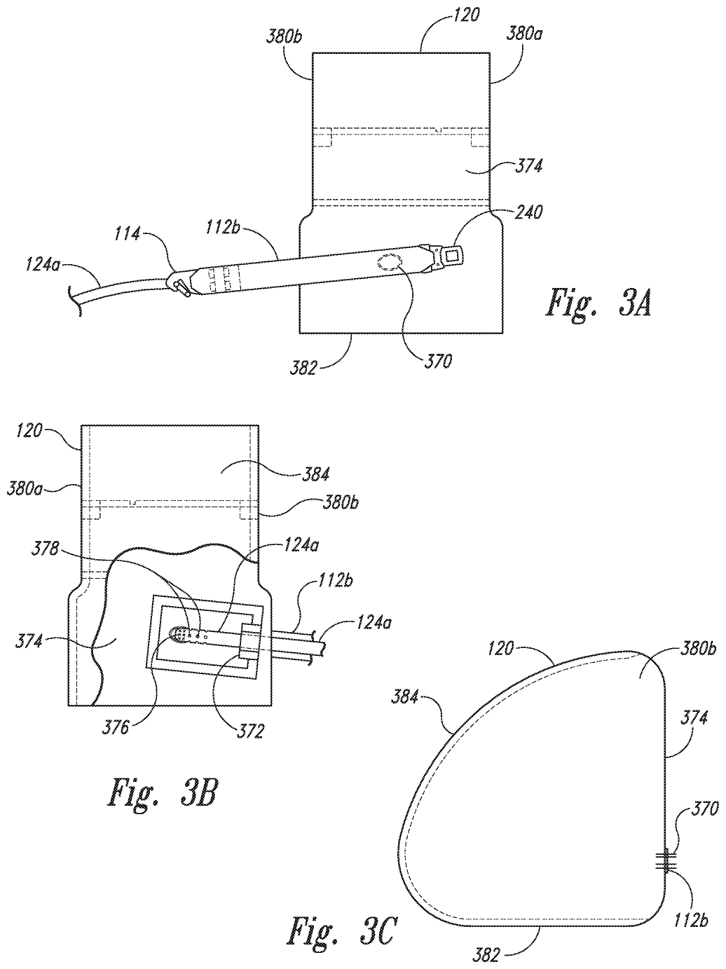

Similarly, rapid expansion of the compressed gas flowing into the under-seat airbag 130 causes the airbag 130 to rapidly expand and rupture or otherwise separate the tear seams 234a-c, causing the cover 134 to quickly move away from the airbag 130 so that the airbag 130 can rapidly inflate to full deployment in, for example, about 40 to 55 ms. Accordingly, in some embodiments the lap belt airbag 120 and the under-seat airbag 130 can be configured to inflate and deploy simultaneously, or at least approximately simultaneously, in about 55 ms or less. Additional details regarding deployment of the lap belt airbag 120 and the under-seat airbag 130 are provided below with reference to FIGS. 3A-5C.

The airbag deployment systems described above and elsewhere herein are provided by way of examples of suitable such systems. It should be noted, however, that the various embodiments of the airbags described herein are not limited to use with the particular inflation and/or other systems described above and can also be used with other types of inflation systems without departing from the present disclosure.

FIG. 3A is a rear view, FIG. 3B is a partially cut-away front view, and FIG. 3C is a side view of the lap belt airbag 120 configured in accordance with embodiments of the present technology. Referring to FIGS. 3A-3C together, the lap belt airbag 120 is illustrated in a fully inflated and deployed configuration, and includes a rear portion or panel 374, a bottom panel 382, a front panel 384 and first and second side panels 380a and 380b, respectively. As will be appreciated by those of ordinary skill in the art, although the foregoing portions of the lap belt airbag 120 have been described herein as “panels” for ease of reference, two or more of these panels can be formed from the same piece of material in a flat pattern that is folded about appropriate fold lines and then joined together by one or more seems in a conventional manner.

As shown in FIG. 3A, the second web portion 112b of the seatbelt 118 (FIG. 2) can be sewn or otherwise attached to the rear panel 374 of the airbag 120 via stitching 370 and/or other suitable fastening means proximate to the web connector tongue 240. As shown in FIG. 3B, the rear panel 374 includes an opening 372 (e.g., a slit) through which the first gas hose 124a extends into the interior of lap belt airbag 120. A distal end portion of the first gas hose 124a is attached to the rear panel 374 by stitching 376 and/or other suitable fastening means known in the art. Additionally, the first gas hose 124a includes a plurality of openings 378 proximate the distal end portion that enable the high-pressure gas from the inflator 242 (FIG. 2) to rapidly flow into the lap belt airbag 120 for inflation thereof.

In some embodiments, the lap belt airbag 120 can have a generally triangular or “wedge” profile shape when the lap belt 120 is fully inflated as shown in FIG. 3C. More specifically, in some embodiments the rear panel 374 can extend generally perpendicular to the bottom panel 382, and the front panel 384 can have a generally convex and curved shape that extends at an angle to connect the bottom panel 382 to the rear panel 374. Additionally, in some embodiments, the lap belt airbag 120 can be configured so that the rear panel 374 does not extend past the chest of the seat occupant 100 (FIG. 1) when fully inflated. In these embodiments, for example, the airbag 120 would not be positioned in front of the occupants head when fully inflated. In other embodiments, the lap belt airbag can have other shapes and sizes.

Although not shown, in some embodiments the lap belt airbag 120 can include one or more vents (e.g., passive vents or active vents) that enable the airbag 120 to quickly deflate after deployment. For example, in some embodiments the airbag 120 can include an opening, e.g., a hole; a tear seam that ruptures when the airbag fully inflates and reaches a sufficient internal pressure; and/or another form of “passive” vent. In other embodiments, the lap belt airbag 120 (and/or the under-seat airbag 130) can include an active vent as described in one or more of the patents or patent applications incorporated herein by reference. In yet other embodiments, airbag vents can be omitted.

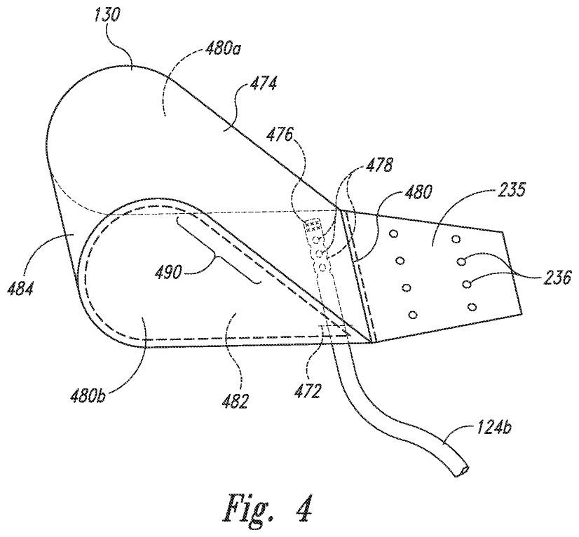

FIG. 4 is an isometric top view of the under-seat airbag 130 in the inflated configuration, configured in accordance with embodiments with the present technology. In some embodiments, the under-seat airbag 130 includes an upper or top panel 474, a bottom panel 482, a front panel 484, and first and second side panels 480a and 480b, respectively. In the illustrated embodiment, the top and bottom panels 474 and 482, respectively, can be generally flat and define an acute angle therebetween (e.g., an angle of from about 10 degrees to about 60 degrees, or from about 15 degrees to about 50 degrees, or about 45 degrees). Additionally, the front panel 484 can be at least generally rounded as it transitions from the bottom panel 482 to the top panel 474. The foregoing configuration can give the under-seat airbag 130 a generally tapered or triangular profile shape that, as described in greater detail below, can advantageously raise the forward edge portion of the seat cushion 108 more than the aft edge portion during inflation.

The bottom panel 482 can include an opening 472 (e.g., a slit) that enables the second gas hose 124b to extend into the interior volume of the under-seat airbag 130. A distal end portion of the second gas hose 124b can be fixedly attached to the bottom panel 482 by stitching 476 or other suitable fastening means known in the art. Additionally, the distal end portion of the second gas hose 124 includes a plurality of apertures or openings 478 that enable the high-pressure gas from the inflator 242 (FIG. 2) to rapidly flow into the under-seat airbag 130 for inflation thereof.

The under-seat airbag 130 can further include the attachment panel 235 that extends rearwardly from a seam 488 that joins the aft edge portion of the top panel 474 to the aft edge portion of the bottom panel 482. The attachment panel 235 can be composed of one or more layers of airbag material that are not inflated during airbag deployment. Rather, the attachment panel 235 can include a plurality of the openings 236 described above with reference to FIG. 2 that receive fasteners or other means for attaching the under-seat airbag 130 and its cover 134 (FIG. 2) to the seat pan 132 as described above with reference to FIG. 1.

In some embodiments, the under-seat airbag 130 includes one or more tear seams 490 that prevent the airbag 130 from fully inflating if the seat occupant is in a brace position. More specifically, the tear seam 490 can be a pressure sensitive seam that ruptures if the internal pressure within the airbag 130 prematurely exceeds a preset maximum as a result of the occupant's upper torso being positioned on or just above the occupant's thighs, as would be the case if the occupant was in the brace position. Preventing the under-seat airbag 130 from fully inflating when the occupant is in the brace position reduces the ability of the airbag 130 to push the occupant upwardly and out of the brace position (which is a relatively safe position in a crash event). Additionally, the tear seam 490 can also rupture once the under-seat airbag 130 fully inflates so that the airbag 130 quickly deflates and does not impede occupant egress away from the seating area. In other embodiments, the airbag 130 can include one or more vents, such as one or more vent holes, that enable the airbag 130 to quickly deflate after inflation.

The under-seat airbag 130 and the lap belt airbag 120 and can be manufactured using various types of suitable airbag materials and construction techniques known to those of ordinary skill in the art. For example, in some embodiments the airbags 120 and 130 can be constructed by sewing together a plurality flat panels or sheets of suitable material, such as silicone coated nylon fabric (e.g., 315 denier silicone coated woven nylon fabric), with a suitable thread using known techniques. In other embodiments, air bags configured in accordance with the present disclosure can be constructed using other suitable materials and construction techniques known in the art.

The airbag deployment, inflation and/or vent systems described above and elsewhere herein are provided by way of example of suitable such systems. It should be noted, however, that the various embodiments of the airbags described herein are not limited to use with the particular inflation and/or other systems described above, but can also be used with other types of inflation and/or vent systems without departing from the present disclosure.

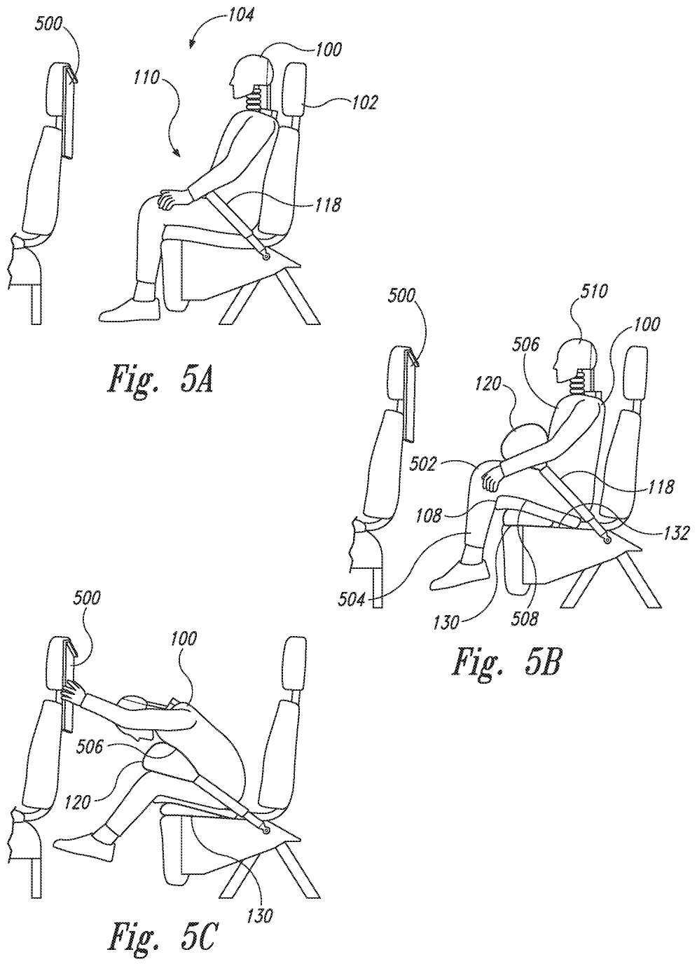

FIGS. 5A-5C are a series of side views illustrating various stages of deployment of the lap belt airbag 120 and the under-seat airbag 130 in accordance with embodiments with the present technology. Referring first to FIG. 5A, this Figure illustrates the airbags 120, 130 in a pre-deployment stage in which the occupant 100 is seated in the seat 102 in the seating area 104 with the lap seatbelt 118 properly secured around the occupant's waist. In FIG. 5A, the seat 102 is a forward-facing seat positioned behind a strike hazard 500. The strike hazard 500 can be virtually any type of structure typically found in front of a passenger seat or other seat (e.g., a pilot seat, flight attendant seat, etc.) on an aircraft, and can include, for example, the seatback of the seat positioned directly in front of the seat 102, a closet or galley wall or partition, a monument, etc. Although the seat 102 is illustrated as a forward-facing seat, in other embodiments the seat 102 can be an oblique seat as described above.

FIG. 5B illustrates the seating area 104 at the initial stage of a crash or other rapid deceleration event above a preset magnitude. The rapid deceleration event causes the occupant's torso 506 to begin moving forward about the lap belt 118. The event also causes the airbag deployment system 200 described in detail above with reference to FIG. 2 to initiate rapid inflation of the lap belt airbag 120 and the under-seat airbag 130. As the under-seat airbag 130 inflates, it raises at least a forward portion of the seat cushion 108 and presses upwardly on the occupant's thighs 508 just behind the occupant's knees 502. This drives the occupant's legs 504 upwardly toward the occupant's torso 506. At the same time, the lap belt airbag 120 inflates and expands between the occupant's torso 506 and the occupant's thighs 508 as the occupant 100 continues to rotate forward about the lap belt 118. As the occupant's legs 504 move upwardly in response to inflation of the under-seat airbag 130, the momentum of the legs 504 is reacted by the occupant's torso 506 through the lap belt airbag 120. The upward momentum of the legs 504 reduces the forward rotation of the torso 506 and the overall forward excursion of the occupant's head 510 toward the strike hazard 500. Additionally, lifting the occupant's legs 504 in this manner reduces the tendency of the occupant 100 to translate forward on the seat pan 132, which further leads to a reduction in forward head excursion.

FIG. 5C illustrates the occupant 100 at a state of maximum forward head excursion. As this view illustrates, the combination of the inflated under-seat airbag 130 and the inflated lap belt airbag 120 can substantially reduce forward head excursion toward the strike hazard 500. Additionally, it is believed that reduction of the forward head excursion in the forgoing manner can also reduce lumbar loads and potential injuries to the occupant 100.

Although embodiments of the restraint system 110 described above include the combination of the under-seat airbag 130 and the lap belt airbag 120, in other embodiments the lap belt airbag 120 can be omitted, and the under-seat airbag 130 can be utilized alone as described above to reduce occupant forward head excursion.

One advantage of reducing occupant head excursion with the airbags 130 and/or 120 described above is that it enables airlines to place seats closer to potential head strike hazards, while still maintaining enough distance to the head strike hazard to avoid potentially injurious contact by the occupant in the event of a crash or other rapid deceleration event. Another benefit of embodiments of the present technology is that by concealing the under-seat airbag 130 beneath the seat cushion 108 and/or integrating the airbag 130 into the seat cushion 108, the airbag does not affect the cosmetics of the seating area 104. Additionally, by positioning the under-seat airbag 130 beneath the cushion 108 or a potion thereof, it does not adversely affect the comfort of the seat 102 for the occupant 100.

Various airbag systems and associated components are described in U.S. Pat. Nos.: 5,984,350; 6,957,828; 6,439,600; 6,535,115; 6,217,066; 7,665,761; 7,980,590; 8,439,398; 8,556,293; 8,469,397; 8,403,361; 8,818,759; 8,523,220; 9,156,558; 9,176,202; 9,352,839; 9,944,245; 9,511,866; 9,925,950; in U.S. patent application Ser. Nos.: 13/170,079; 14/468,170; 14/808,983; and in U.S. Provisional Patent Application No.: 62/495,602, each of which is incorporated herein by reference in its entirety. Indeed, any patents, patent applications and other references identified herein are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A restraint system for use with a seat in an aircraft, the restraint system comprising:
a web configured to be fastened around an occupant seated in the seat;
a first airbag attached to the web and configured to inflate therefrom; and
a second airbag configured to be positioned proximate a base portion of the seat and inflate upwardly therefrom beneath the occupant.

2. The restraint system of claim 1 wherein the web is a lap web configured to be fastened around the occupant's waist.

3. The restraint system of claim 1 wherein the second airbag is configured to inflate upwardly beneath the occupant's thighs to raise the occupant's knees toward the occupant's torso.

4. The restraint system of claim 1 wherein:
the web is a lap web configured to be fastened around the occupant's waist;
the first airbag is configured to inflate outwardly from the lap web between the occupant's torso and the occupant's thighs; and
the second airbag is configured to inflate upwardly beneath the occupant's thighs to raise the occupant's knees toward the first airbag.

5. The restraint system of claim 1, further comprising at least one inflator in fluid communication with the first and second airbags, wherein the at least one inflator is configured to rapidly inflate the first and second airbags simultaneously, or at least approximately simultaneously, in response to the aircraft experiencing a dynamic event above a preset magnitude.

6. The restraint system of claim 1 wherein the base portion of the seat includes a seat pan and a seat cushion positioned above the seat pan, and wherein the second airbag is configured to be positioned between the seat pan and the seat cushion.

7. The restraint system of claim 1 wherein the base portion of the seat includes a seat pan and a seat cushion positioned above the seat pan, and wherein the second airbag is integrated into a portion of the seat cushion.

8. The restraint system of claim 1 wherein the first airbag is configured to not extend above the occupant's chest when fully inflated.

9. The restraint system of claim 8 wherein the first airbag includes a rear panel adjacent to a bottom panel, and wherein the first airbag is configured to inflate such that the rear panel is oriented generally parallel to the occupant's torso and the bottom panel is oriented generally parallel to the occupant's thighs and approximately perpendicular to the rear panel.

10. The restraint system of claim 1 wherein the second airbag is configured to inflate into a generally triangular shape in which a forward end portion is taller than a rear end portion.

11. The restraint system of claim 10 wherein the second airbag includes a top panel joined to a bottom panel at a seam, and wherein the second airbag is configured to inflate such that the top panel extends from the seam at an acute angle relative to the bottom panel.

12. An airbag system for use with a seat in an aircraft, the airbag system comprising:
a first airbag configured to inflate between the occupant's torso and the occupant's thighs; and
a second airbag configured to inflate upwardly beneath the occupant's thighs to raise the occupant's knees toward the occupant's torso.

13. The airbag system of claim 12 wherein the second airbag is configured to inflate simultaneously, or at least approximately simultaneously, with the first airbag.

14. The airbag system of claim 12 wherein the first airbag is configured to not extend above the occupant's chest when fully inflated.

15. The airbag system of claim 14 wherein the first airbag includes a rear panel adjacent to a bottom panel, and wherein the first airbag is configured to inflate such that the rear panel is oriented generally parallel to the occupant's torso and the bottom panel is oriented generally parallel to the occupant's thighs and approximately perpendicular to the rear panel.

16. The airbag system of claim 12 wherein the first airbag is configured to inflate outwardly from a web fastened around the occupant's waist, and the second air bag is configured to inflate beneath at least a portion of a seat cushion.

17. A method for reducing forward head excursion of an occupant seated in an aircraft seat during a rapid deceleration event, the method comprising:
attaching a lap web to opposite side portions of the aircraft seat, wherein the lap web is configured to be fastened around the waist of the occupant, and wherein the lap web carries a first airbag;
positioning a second airbag proximate a base portion of the seat;
inflating the first airbag outwardly from the lap web between the occupant's torso and thighs in response to detecting the rapid deceleration event; and
inflating the second airbag upwardly from the base portion beneath the occupant's thighs in response to detecting the rapid deceleration event.

18. The method of claim 17 wherein inflating the second airbag raises the occupant's knees toward the occupant's torso.

19. The method of claim 17 wherein the base portion of the seat includes a cushion, and wherein inflating the second airbag includes raising a forward edge portion of the cushion more than a rear edge portion of the cushion.

20. The method of claim 17 wherein inflating the first airbag includes inflating a generally wedge-shaped airbag having a bottom panel extending generally parallel to the occupant's thighs and a rear panel extending generally parallel to the occupant's torso and not extending above the occupant's chest.
